(19) United States
(12) Patent Application Publication
(10) Pub. No.: US 2016/0343269 A1
(43) Pub. Date: Nov. 24, 2016

(54) SYSTEMS AND METHODS FOR ATHLETIC COMPETITION

(71) Applicant: Casey Wright, Indianapolis, IN (US)

(72) Inventor: Casey Wright, Indianapolis, IN (US)

(21) Appl. No.: 14/717,108

(22) Filed: May 20, 2015

(51) Int. Cl. G09B 19/00

(52) U.S. Cl. CPC G09B 19/0038

(57) ABSTRACT

Kits and methods for a hybrid athletic/martial competitions and games, including lesson plan(s), where the lesson plan(s) include lesson(s), and where the lesson(s) include lesson identifier(s) and activity field(s); multimedia aid(s), where the multimedia aid(s) include first multimedia aid screen(s), second multimedia aid screen(s), and instruction field(s) overlaid on the first multimedia aid screen(s); graduation guide(s), where the graduation guide(s) include graduation level(s), and where the graduation level(s) include first graduation level(s), where the first graduation level(s) include first graduation requirement(s), and second graduation level(s), where the second graduation level(s) include second graduation requirement(s) being more physically challenging to perform than the first graduation requirement(s). Further aspects include obstacle(s), graduation indicia, multimedia reference icon(s), reference tag(s), scoring guide(s), and/or audiovisual presentation(s).

### TECHNICAL FIELD OF THE INVENTION

The present novel technology relates generally to athletic competition, and more particularly to a hybrid athletic/martial game competition.

### BACKGROUND OF THE INVENTION

Traditional gymnastics competitions typically require high levels of technical and physical ability and often times exclude of certain age and/or gender groups. Gymnastics competitions also typically require use of specific gymnastics-oriented equipment, such as balance beams, gymnastics bars, and the like, in their traditional roles, which is unappealing to certain groups of individuals due to negative sociological perceptions. Further, certain more “modern” physical and gymnastic activities have become more mainstream but rely on individualism and/or physicality that are unavailable to, or impractical for, many potential participants. Thus, there remains need for a more inclusive competition system and environment for participants. The present invention addresses this need.

### BRIEF DESCRIPTION OF THE DRAWINGS

FIG. 1 is a perspective view of a kit containing hybrid athletic/martial competition system.

FIG. 2 is a perspective view of an example environment in which hybrid athletic/martial competition system may exist.

FIG. 3A is a process flow diagram associated with the environment of FIG. 1 using hybrid athletic/martial competition system.

FIG. 3B is a process flow diagram continued from FIG. 3A and associated with the environment of FIG. 1 using hybrid athletic/martial competition system.

FIG. 3C is a process flow diagram continued from FIG. 3B and associated with the environment of FIG. 1 using hybrid athletic/martial competition system.

FIG. 3D is a process flow diagram continued from FIG. 3C and associated with the environment of FIG. 1 using hybrid athletic/martial competition system.

FIG. 4 is a schematic view of an example lesson used with hybrid athletic/martial competition system.

FIG. 5A is a schematic view of an example multimedia aid used with hybrid athletic/martial competition system depicting a first multimedia frame.

FIG. 5B is a schematic view of an example multimedia aid used with hybrid athletic/martial competition system depicting a second multimedia frame.

FIG. 6 is a schematic view of an example graduation guide used with hybrid athletic/martial competition system.

### DETAILED DESCRIPTION

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

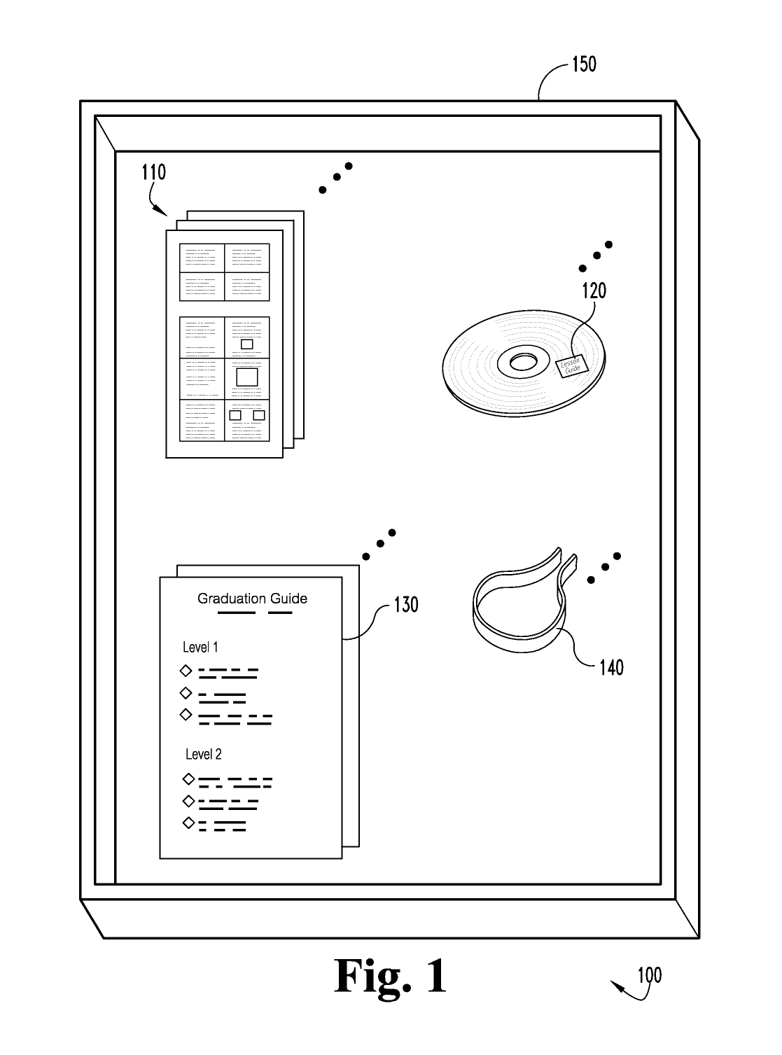

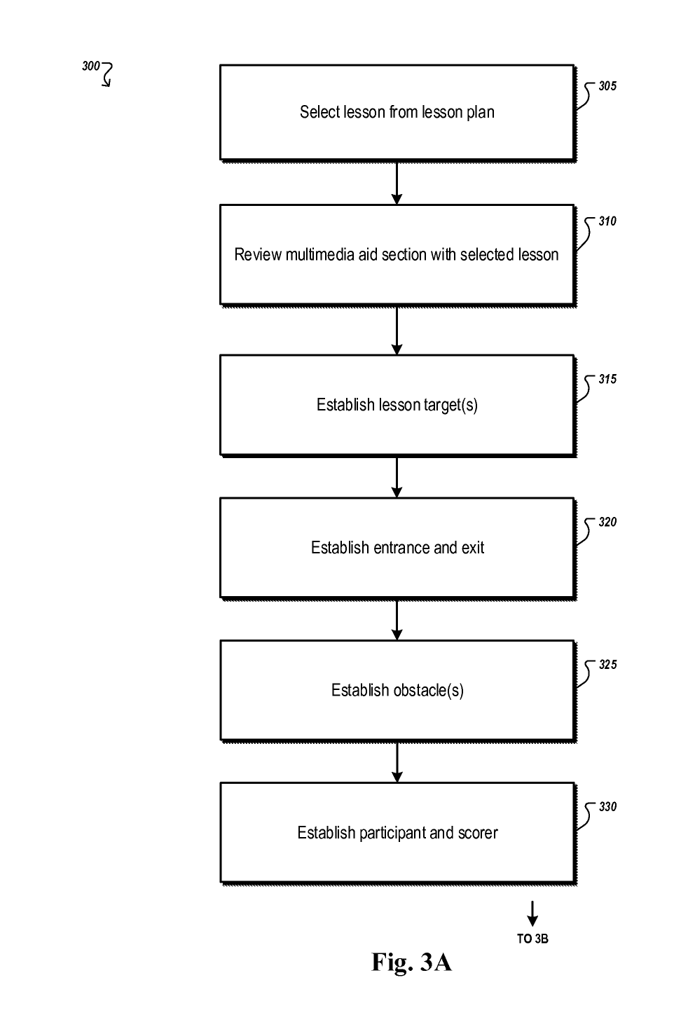

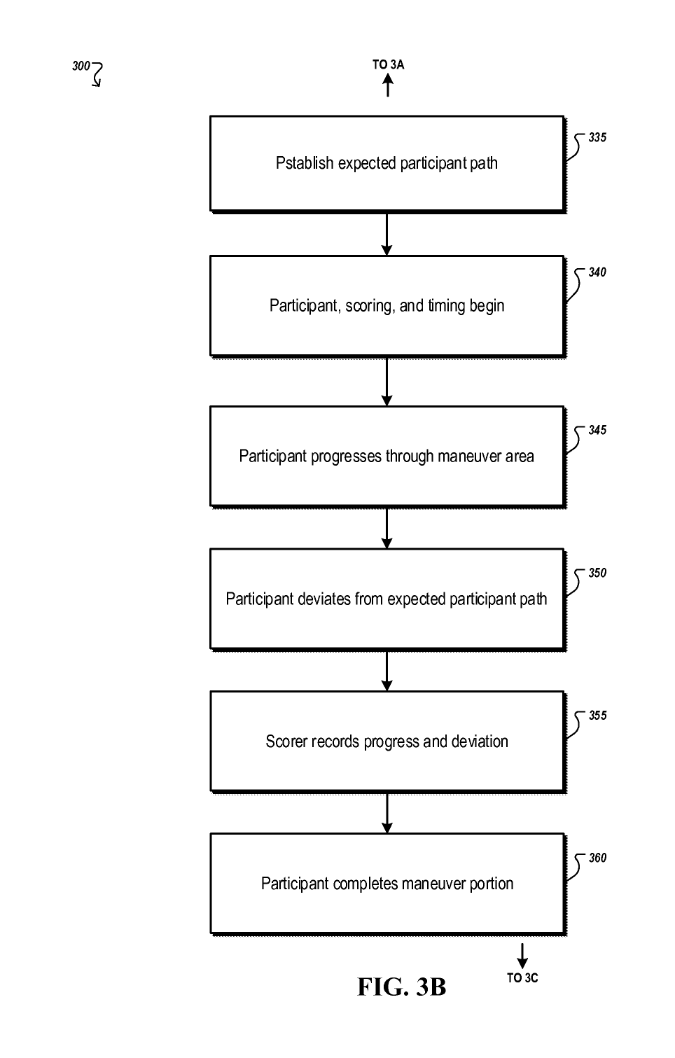

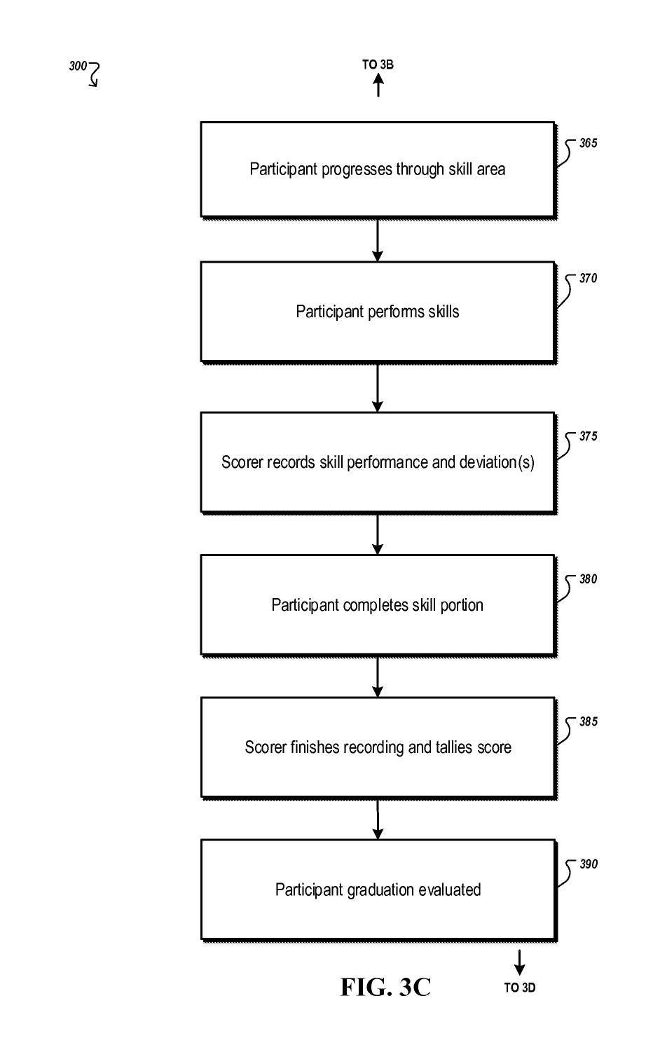

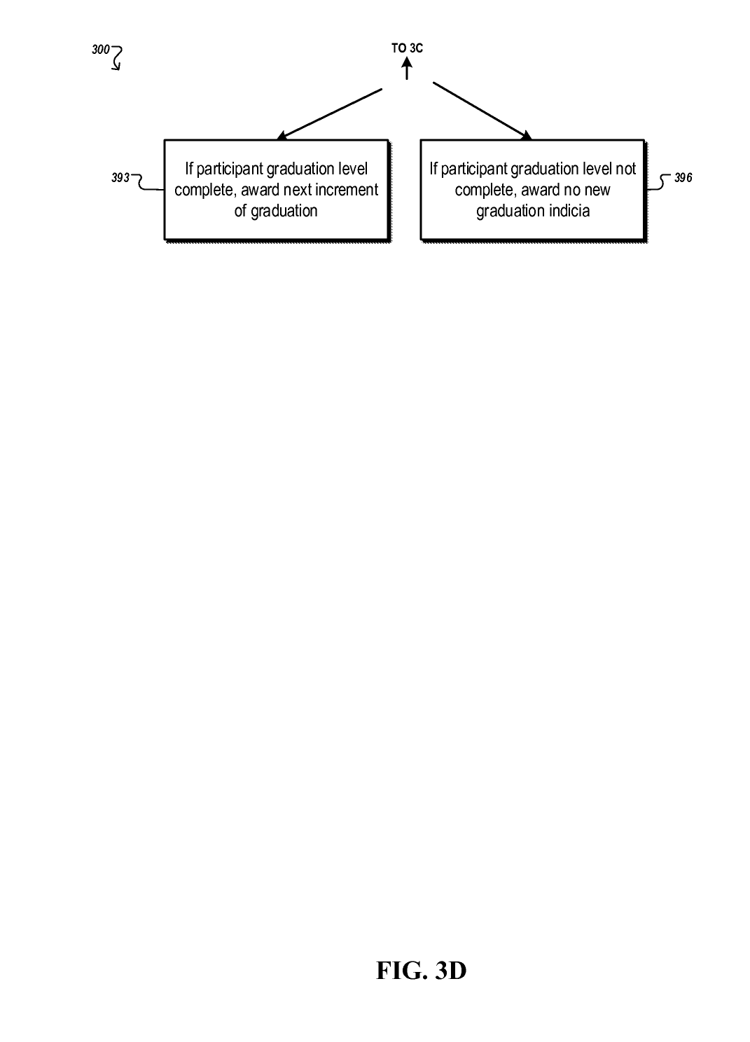

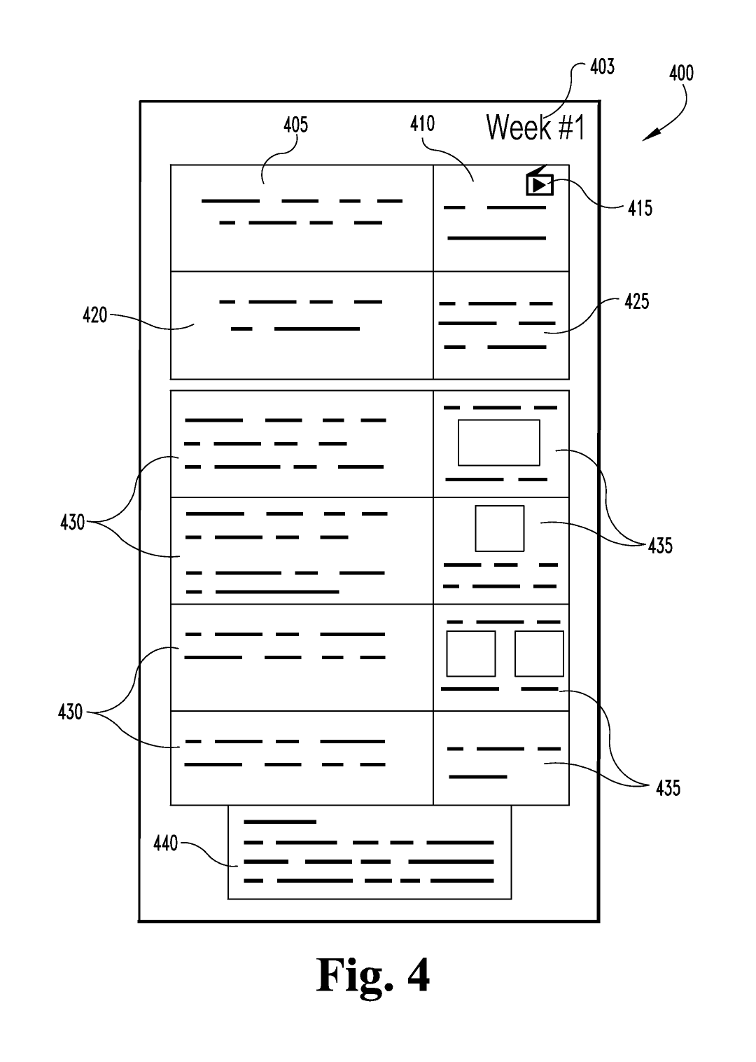

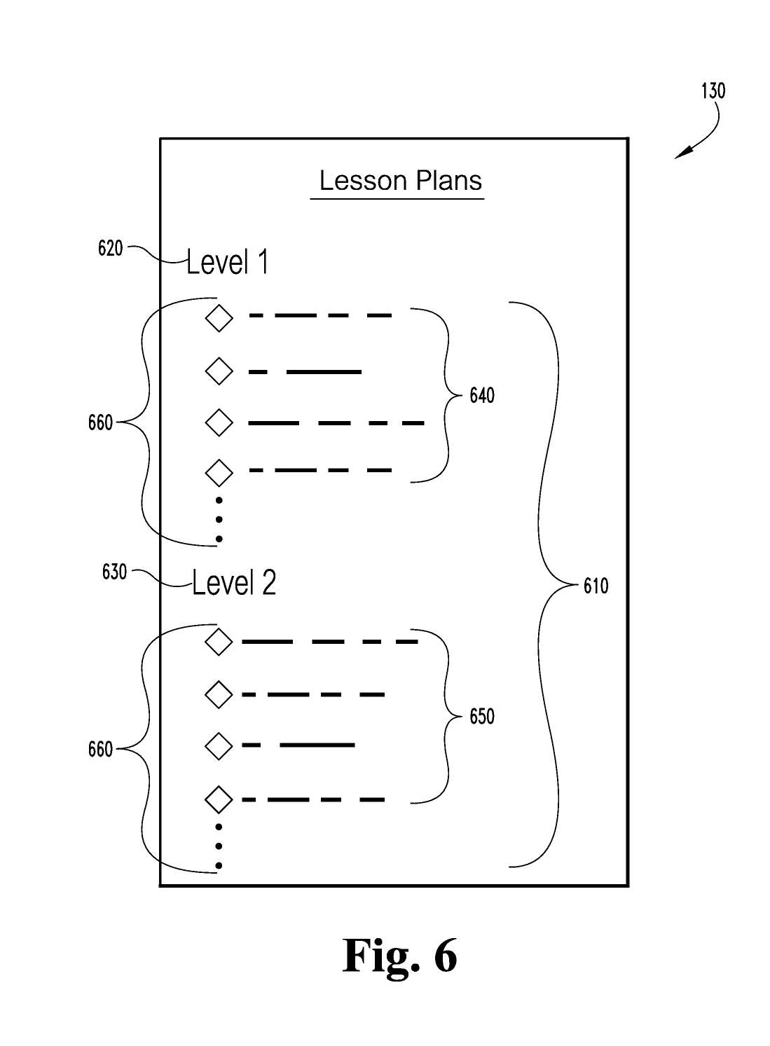

FIGS. 1-6 relate to a first embodiment of the novel technology, hybrid athletic/martial competition system 100 typically including lesson plan 110, multimedia aid 120, graduation guide 130, and/or graduation indicia 140. In some implementations, lesson plan 110, multimedia aid 120, graduation guide 130, and/or graduation indicia 140 typically may be included in hybrid athletic/martial competition system kit 150. In some additional implementations, hybrid athletic/martial competition system kit 150 may also include obstacle(s) 235 (described below).

Typically, hybrid athletic/martial competition system 100 may be taught to one or more individuals through a self-teaching lesson plan and/or an instructor-guided lesson plan, each and/or both being included in lesson plan 110. Multimedia aid 120 typically may be associated with lesson plan 110 to provide visual, audio, and/or tactile interactivity to lesson plan 110. Graduation guide 130 typically may be a requirement scale that may be used to determine whether an individual has fully completed a specific mastery-type level and associated requirements. Upon completion of a graduation level's requirements (e.g., by performing certain skills), an individual may be awarded one or more graduation indicia 140 (e.g., a belt, badge, headband, shroud, cloak, cape, and/or the like). Typically, lesson plan 110, multimedia aid 120, and/or graduation guide 130 may be literature and/or instructions included on one or more digital and/or analog mediums. Each of these elements is explained further below.

In some implementations, hybrid athletic/martial competition system kit 150 typically may be constructed and distributed including lesson plan 110, multimedia aid 120, graduation guide 130, and/or graduation indicia 140.

Example environment 200 typically may include entrance 205, exit 210, maneuver area 215, skill area 220, participant 225, participant path 230, obstacle(s) 235, deviation 240, scorer 245, and/or score 250. Participant 225 (e.g., system 100 student, instructor, and/or the like) typically may progress through environment 200 from entrance 205 to exit 210 while being scored (e.g., with score 250) by scorer 245.

Entrance 205 typically may be a beginning point for participant 225 to commence his or her participant path 230 into maneuver area 215 (or in some implementations into skill area 220) and through environment 200. For example, it may be a “START” line, a doorway, an arbitrary point, and/or any other point of ingress for environment 200. Typically, at the point of passing entrance 205, scorer 245 may begin timing participant 225. From this point, participant typically may continue along an expected path (e.g., participant path 230 excluding deviation 240) in a continuous progression (unlike standard gymnastics and/or traditional sport routines, which may typically involve landing/sticking individual skills) typically defined as away from entrance and toward exit 210.

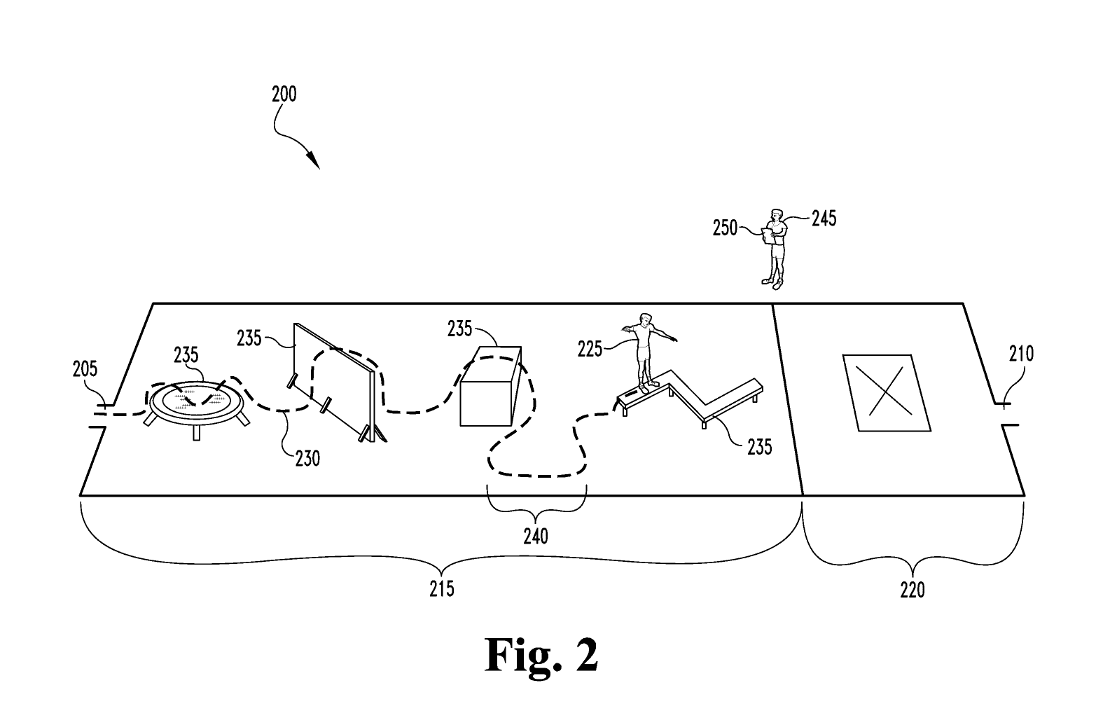

In some implementations, entrance 205 may define the ingress point for skill area 220 rather than maneuver area 215. That is, participant 225 may first progress through skill area 220 and then through maneuver area 215, rather than through maneuver area 215 and then skill area 220 as depicted in FIG. 2.

Exit 210 typically may be a point of egress from environment 200 by which participant 225 and participant 225's expected participant path 230 may progress. For example, as depicted in FIG. 2, exit 210 may be oppositely disposed on environment 200's bound from entrance 205. However, exit 210 and/or entrance 205 may be located on any environment 200 boundary. Typically, scorer 245 may stop timing participant 225 after participant passes exit 210 to determine the time spent by participant 225 in environment 200.

As above with entrance 205, exit 210 may be the point at which participant 225 leaves skill area 220, while in other implementations, exit 210 may be the point at which participant 225 leaves maneuver area 215.

Maneuver area 215 typically may be a portion of environment 200 where participant 225 progresses past one or more obstacles 235 (described in greater detail below). For example, participant 225 may follow participant path 230 to bounce, roll, vault, run, and/or otherwise traverse obstacles 235 to progress from entrance 205 to exit 210.

In some implementations, maneuver area 215 may have a physical and/or arbitrary boundary, where participants 225 must remain inside. For example, maneuver area 215 may be a bounded and/or elevated platform. In other m, maneuver area 215 may be more general area, such as a large, open floor area.

Similarly, skill area 220 typically may be a portion of environment 200 in which participant 225 performs one or more actions and/or skills. For example, participant 225 may have to perform one or more athletic and/or hybrid athletic/martial skills (e.g., kip-ups, vault, back flip, front flip, cartwheel, rolls, kicks, punches, and/or the like). Scorer 245 typically may monitor conformity of participant 225's movement to an expected action scheme.

In some implementations, skill area 220 may have a physical and/or arbitrary boundary, where participants 225 must remain inside. For example, skill area 220 may be bounded and/or elevated platform. In other implementations, skill area 220 may be more general area, such as a large, open floor area.

Participant path 230 typically may be a route followed by participant 225 through environment 200. An ideal participant path 230 typically may consist of the most efficient route from entrance 205 to exit 210 while traversing obstacles 235 and maintaining a progression towards exit 210.

In some implementations, participant path 230 may be characterized by lateral motion, while in other implementations, participant 225 may perform no or limited lateral movement. For example, in some implementations, participant path 230 may be over two obstacles 235 requiring straight line traversing (e.g., a straight beam and a wall to vault). In other implementations, however, participant 225

Obstacle(s) 235 typically may be placed throughout maneuver area 215 of environment 200 for participants 225 to traverse. Obstacles 235 may be, for example, blocks, walls, blocks, poles, rings, beams, ramps, stairs, trampolines, hoops, and/or the like. Obstacles 235 typically may also include one or more other participants 225 and/or other individuals associated with system 100. There typically may be a mix of obstacle 235 types in environment 200 for participant 225 to traverse, but there may alternatively be any quantity, size, and/or other variation of obstacle 235 occurrence for environment 200.

Further, in some implementations, there may be a single, large obstacle 235, while in other implementations, there may be a plurality of smaller and/or mixed-size obstacles 235. For example, there may be a single, large wall to traverse for one environment 200, while in another environment there may be twenty obstacles 235 ranging from small to large. Some implementations may tailor obstacle 235 schemes for different participant 225 physicality, size, endurance, preference, and/or the like. For example, a team of trained acrobats and/or athletes may have a long, difficult course, while a group of young children may have a simpler environment 200 design for a birthday party.

In some other implementations, obstacles 235 may be included in hybrid athletic/martial competition system kit 150. For example, while some implementations of kit 150 may not allow larger obstacles 235, such as balance beams, walls, and/or the like, kit 150 may include smaller, inflatable, and/or assemblable obstacles 235 (e.g., trampolines, stacking walls, extendable beams, and/or the like). In still other implementations, kit 150 may include one or more larger containers including obstacles that may not otherwise be shipped in a smaller kit 150 container including lesson plan 110, multimedia aid 120, graduation guide 130, graduation indicia 140, and/or the like.

Deviation 240 typically may be an inefficient and/or otherwise unplanned variance from participant 225's expected participant path 230, typically such that participant path 230 travels in a direction away from exit 210 (and typically towards entrance 205). For example, as depicted in FIG. 2, participant 225 travels on participant path 230 from entrance 205, past an obstacle 235 (depicted like a trampoline and/or platform), toward and past a wall-like obstacle 235, and over box-like obstacle 235 before having a minor misstep causing participant path 230 to trend away from exit 210, which may be regarded as deviation 240. Participant 225 then adjusts his or her movement and continues participant path 230 along an angled beam-type obstacle 235.

In some implementations, deviations 240 may be used as a negative scoring adjustment for score 250 (described below). For example, in some implementations, deviations 240 may deduct ten points, percent, and/or like value from participant 225's score 250 by scorer 245 when perceived by scorer 245 and/or any other party. In some further implementations, deviations 240 may deduct a variable value based on a plurality of factors and/or variables (e.g., participant 225's skill level, past performance, challenge level, graduation level 610, and/or the like).

Scorer 245 typically may be another individual and/or participant 225 associated with system 100. For example, scorer 245 may be an instructor, another participant 225, a competition judge for system 100 competitions, and/or the like. Scorer 245 typically may be oriented adjacent to environment 200 to determine participant 225's progress through environment 220, but scorer 245 may be located in any desired location (e.g., above environment 200, at a remote location for viewing environment 200 and/or participant 225 through remote feeds, and/or the like).

In some implementations, scorer 245 may be and/or include an automated system including video capture sensors, motion detection devices, adjustable variation thresholds, and/or control units. For example, scorer 245 may be an array of motion detection sensors that may assess deviations 240 when participant 225 in environment 200 moves toward entrance 205 by more than one foot.

Score 250 typically may be based on participant 225's time spent in environment, efficiency in traversing obstacles 235, adherence to participant path 230, skills performed, lesson completion (e.g., reciting lesson focus field 405, mantra, performing requirements from physicality field 425, and/or the like) and/or the like. For example, environment 200 may have a time limit (e.g., five minutes, ten minutes, fifteen minutes, and/or the like) assessed that may begin as soon as participant 225 passes entrance 205 and end when participant 225 passes exit 210 (assuming participant 225 is not still located within environment 200 bounds at the expiration of the time limit).

In some implementations, score 250 and time to clear environment 200 may be determined by a plurality of factors (e.g., participant 225's skill, course difficulty, number of obstacles 235, etc.). For example, a short course having only two simple obstacles 235 may have a time limit of five minutes, while a long course having five difficult obstacles 235 may have a time limit of fifteen minutes.

In some other implementations, time penalties equal to certain values (e.g., two points, ten percent, and/or the like) may be deducted for each deviation 240. For example, if participant 225 is assessed two deviations 240 by scorer 245 in environment 200 having a ten-minute time limit, and assessed time penalties for deviations 240 are equivalent to ten percent of the total time limit, participant 225 would need to clear environment 200 in only eight minutes (ten minutes less two, one-minute time penalties).

In additional implementations, score 250 may be a numerical score that may be based on conformity with an expected participant path 230 (e.g., zero points for failing to clear/bypassing obstacle 235, one point for clearing obstacle 235 with effort and committing deviation 240, two points for clearing obstacle 235 with minor effort but no deviation, three points for clearing effort without deviation or visible effort, etc.); speed in clearing course (e.g., one point for clearing course with less than one minute remaining of time limit, two points for clearing course with greater than one minute remaining of time limit, etc.); aesthetic flair (e.g., extra one point for traversing obstacles 235 with additional aesthetic flourishes, such as flips, twists, etc.); and/or the like. In this manner, participants 225 may be encouraged to customize their progress and/or path 230 through environment 200 by customizing expected maneuvers, skills, and/or the like.

Similarly, points may be deducted from a total possible score (e.g., twenty points, fifty points, etc.) for factors including, but not limited to, deviations 240, staggered movement, falling down, noise, and/or the like. In some implementations, completing environment 200 may require not only passing exit 210 within a time limit but also doing so while accruing a requisite point threshold.

In some alternative implementations, score 250 may be a simple pass/fail determination. For example, knocking over an obstacle, failing to traverse it efficiently, and/or similar variance may result in awarding zero points for traversing an obstacle 235. Further, traversing an obstacle 235 as expected and continuing to the next obstacle 235 may result in awarding a full score for that obstacle 235 to participant 225.

In yet other implementations, score 250 may be determined based on a mix of the above numerical and/or pass/fail schemes. For example, participant 225 may receive either zero or full points (pass/fail) for traversing obstacle 235, but participant 225 must also complete certain skills in skill area 220 in conformity using a numerical scale from one to ten points.

In some further implementations, score 250 may be established as a threshold to be reached for graduation to new graduation levels 610. For example, participant 225 may complete and receive credit for graduation requirements (e.g., first graduation requirements 640, second graduation requirements 650, and/or the like) and/or requirement completion fields 660. Participant 225 may be required to complete all completion fields 660 over a course of time including several environment 200 attempts and configurations, while in other implementations participant 225 may be required to complete all completion fields 660 during a single environment 200 attempt and configuration.

Activity flow diagram 300 typically depicts the activities of participant 225 from entrance 205 through exit 210 and typically may include the steps of select lesson from lesson plan 305; review multimedia aid section with selected lesson 310; establish lesson target(s) 315; establish entrance and exit 320; establish obstacle(s) 325; establish participant and scorer 330; establish expected participant path 335; participant, scoring, and timing begin 340; participant progresses through maneuver area 345; participant deviates from expected participant path 350; scorer records progress and deviation 355; participant completes maneuver portion 360; participant progresses through skill area 365; participant performs skills 370; scorer records skill performance and deviation(s) 375; participant completes skill portion 380; scorer finishes recording and tallies score 385; participant graduation evaluated 390; if participant graduation level complete, award next increment of graduation indicia 393; and/or if participant graduation level not complete, award no new graduation indicia 396. Steps from activity flow diagram 300 typically may be performed by participant 225, other system 100 individuals, and/or like entities.

During the ‘select lesson from lesson plan’ step 305, typically lesson plan 305 may be subdivided into one or more individual lessons 400. For example, participants 225 may meet weekly with an instructor, the first meeting completing the first lesson 400 in lesson plan 110, the next meeting completing the second lesson 400 in lesson plan 110, and so on.

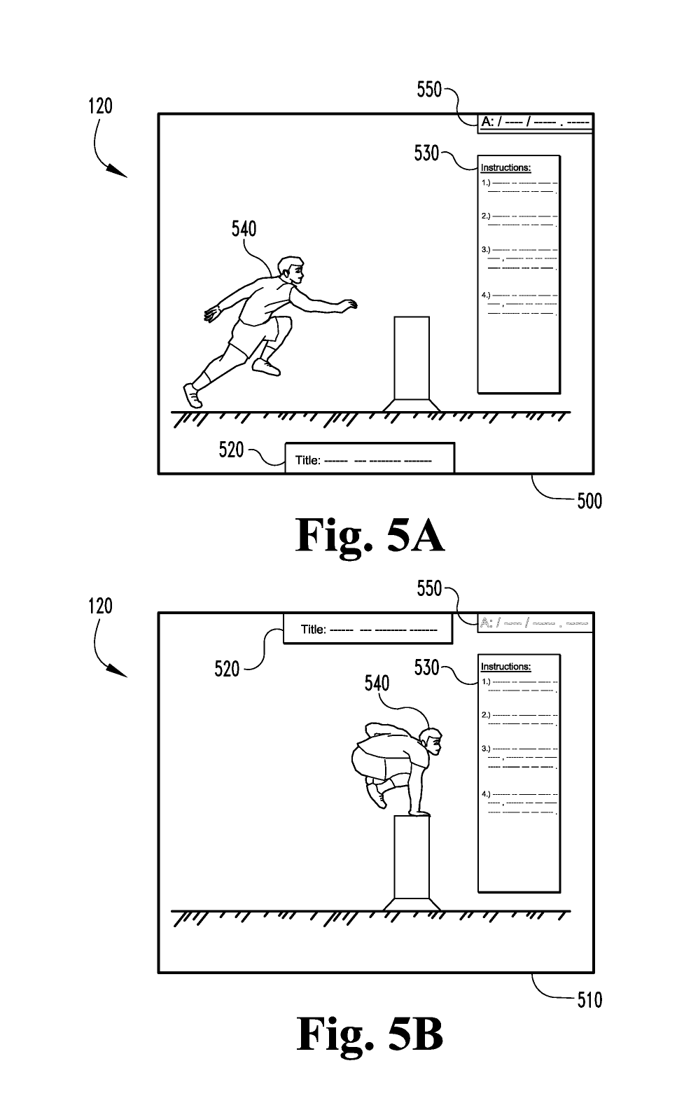

During the ‘review multimedia aid section with selected lesson’ step 310, typically one or more audio/visual multimedia resources may be associated with one or more lessons. These resources typically may also include instructional guidance for performing a maneuver, skill, and/or the like. Thus, an individual (e.g., participant 225 and/or the like) can view the associated multimedia resources to understand a maneuver, skill, and/or the like more easily. FIGS. 5A-5B illustrate such a multimedia resource.

During the ‘establish lesson target(s)’ step 315, lessons typically may include one or more lesson 400 objectives and/or goals, such as learning a new skill, maneuvering past one or more obstacles 235, and/or the like. Participant 225 and/or other system 100 individuals may determine which lesson 400 target(s) he or she wishes to complete. For example, one participant 225 may wish to complete each lesson 400 objective, while other participants 225 may wish to only complete a subset (e.g., only the maneuver or skills) listed in the lesson.

During the ‘establish entrance and exit’ step 320, the ‘establish obstacle(s)’ step 325, and the ‘establish participant and scorer’ step 330, typically environment 200 design and activities within environment 200 may be set and resolved. For example, the individuals to be active in environment 200 may be set as participant 225 and scorer 245. Additionally, environment's entrance 205 and exit 210, at which participant 225 may begin and conclude activity within environment 200, may be set. Further, the obstacle(s) 235 to be traversed by participant 225 and/or judged by scorer 245 may be indicated and set.

In some implementations, randomization of entrance 205, exit 210, obstacles 235, participant 225, scorer 245, and/or other environment 200 variables may occur. For example, participant 225 may select from a list of obstacles 240 and/or skills to traverse and perform, but an automated selection system may choose a subset of participant 225's selections to be presented in environment 200. In some further implementations, participant 225 may be informed of the automated selection system's choices, while in other implementations, the automated selection system's choices may be revealed to participant 225 at the point when participant 225 approaches and/or passes entrance 205.

During the ‘establish expected participant path’ step 335, typically once target obstacles 235 and skills to be attempted are selected, participant 225 and/or other system 100 individuals may establish participant path 230 that may act as an ideal participant path 230 for participant 225 to move along while in environment 200. The expected/ideal participant path 230 typically may allow participant 225 to move through environment 200 while avoiding any deviations 240. Typically, matching the expected/ideal participant path 230 may result in scorer 245 awarding participant 225 a maximum score 250 for the particular environment 200 variables (e.g., difficulty, time, etc.).

At the ‘participant, scoring, and timing begin’ step 340, participant 225 enters environment 200 and maneuver area 215 via entrance 205. Synchronously, scorer 245 and/or some other system 100 individual begins timing and scoring participant 225's progress through environment. In some implementations, timing and/or scoring may be automatically initiated. For example, an automated scoring system may monitor participant 225's process through environment 200 along expected participant path 230 and track conformity and/or deviation 240 from expected participant path 230. Further, automated timing may be implemented through a variety of mechanisms known in the art, including but not limited to, photosensors, break-beam sensors, pressure sensors, and/or the like located at or focused on entrance 205.

The ‘participant progresses through maneuver area’ step 345 refers to the period of time after participant 225 passes entrance 205 of environment 200 but before participant 225 causes deviation 240. During this period, participant 225 traverses multiple obstacles in an efficient and expected manner. Typically, participant path 230 as depicted in FIG. 2 may correspond to and/or closely approximate an expected/ideal participant path 230.

During the ‘participant deviates from expected participant path’ step 350, participant 225 caused a deviation 240 after traversing the immediately prior obstacle 235. For example, participant 225 may land on the wrong foot, turn the wrong direction, and/or perform similar mistakes to commit deviation 240.

During the ‘scorer records progress and deviation’ step 355, scorer 245 records deviation 240 from expected participant path 230. This may be, for example, an immediate deduction at the time when scorer 245 detects deviation 240, while in other implementations, scorer 245 may mark and/or otherwise indicate that a deduction may be made for deviation 240. During this step, scorer 245 may also record participant 225's progress through environment 200, conformity with an ideal/expected participant path 230, and/or the like. For example, scorer 245 may record and/or score participant 225's performance in traversing each obstacle 235 individually, record and/or score participant 225's progress in traversing all obstacles 235 as a group, and/or perform a combination of individual and/or group recording.

During the ‘participant completes maneuver portion’ step 360, participant 225 typically leaves maneuver area 215 (which may be arranged temporally before skill area 220, as depicted in FIG. 2) and enters skill area 220. In some implementations, scorer 245 may record participant 225's pace and the time required for participant 225 to complete/clear maneuver area 215, whereas in other implementations, scorer 245 may transition to monitoring participant 225's progress through skill area 220 without recording participant 225's exit from maneuver area 215.

During the ‘participant progresses through skill area’ step 365 and the ‘participant performs skills’ step 370, participant 225 may perform one or more skills. For example, participant 225 may perform a number of kip-ups, vault, back flip, front flip, cartwheel, rolls, twists, kicks, punches, and/or the like in succession and/or individually. These skills typically may be preselected and/or randomly selected at the time of skill performance. For example, participant 225 and/or another system 100 individual may select from a number of skills described and/or depicted in lesson plan 110, multimedia aid 120, graduation guide 130, and/or the like. In other implementations, skills to be performed by participant 225 in skill area 220 may be selected and/or presented to participant 225 while participant 225 enters and/or resides in skill area 220 (e.g., by a held-up card, a monitor, from vocal command, and/or the like).

During the ‘scorer records skill performance and deviation(s)’ step 375, participant 225 performs one or more skills and scorer 245 monitors participant 225's conformity and/or deviation 240 from expected skill form. For example, expected skill form may be described in literature (e.g., score sheet, lesson plan, and/or the like) and/or known to scorer 245 (e.g., scorer 245 knows front flip must be performed in one fluid motion with participant 225 jumping vertically, rotating forward while in the air, and landing stably on both feet within one foot from the point at which participant 225 jumped). If scorer 245 detects deviation 240 from expected skill form, scorer 245 may make note and/or deduct from potential score 250.

In some implementations, scoring of skill conformity and/or deviation 240 may be automatically monitored and/or scored. For example, a videographic-, photographic-, pressure-, and/or acoustic-sensitive monitoring system may record participant 225's movements during skill performance and/or score recorded values (i.e., representing participant 225's movements during skill performance). Thus, such a system may score participant 225 using a variety of sensors, for example but not limited to, by recording pressure using floor-mounted pressure sensors from participant 225's foot placement and jump, recording participant 225's height and rotation during a front flip, and then again recording pressure using floor-mounted pressure sensors from participant 225's foot placement during landing.

During the ‘participant completes skill portion’ step 380, participant 225 may complete the last of the required skills for performance in skill area 220. For example, participant 225 may be required to do a front flip, a backflip, and a kip-up in succession; after the kip-up, participant 225 may be automatically considered to have completed the skill portion of environment 200 and automatically considered to pass exit 210. Typically, timing may cease at this point and participant 225's total time spent traversing environment 200 may be calculated (i.e., by calculating the difference between the stop time and the start time, by stopping a stopwatch, and/or the like). In some implementations, participant 225 may be further required to physically pass exit 210 before timing may cease. For example, participant 225 may complete the above-described kip-up and then move over a line (or any other boundary) representing exit 210.

During the ‘scorer finishes recording and tallies score’ step 385, scorer 245 typically may cease monitoring participant 225 and review participant 225's conformity and/or deviations 240 from expected participant path 230 from maneuver area 215 and/or skill area 220. Typically, scorer 245 may consult a rubric and/or scoring guidelines (e.g., from lesson plan 110, multimedia aid 120, graduation guide 130, and/or the like). For example, such guidelines may note that the maximum score for a five-obstacle, three-skill, and eight-minute time limit environment 200 may be eighty points. Further, such guidelines may note that ten percent of these eighty points (eight points) may be deducted for each deviation 240 and/or that ten percent of the maximum time limit of eight minutes (forty-eight seconds) may be deducted per deviation 240.

Additionally, such guidelines may note that the maximum time limit and/or maximum score may be adjusted based on graduation level 610. For example, a first graduation level 620 participant 225 may be allowed an extra five-percent time and/or score limit increase when attempting a skill and/or obstacle 235 associated with a higher graduation level. Conversely, a second graduation level 630 participant 225 may be decremented five-percent from the course's time and/or score limit when attempting a skill and/or obstacle 235 associated with a lower graduation level.

During the ‘participant graduation evaluated’ step 390, scorer and/or another individual associated with system 100 may review score 250 and/or other statistics regarding participant 225's attempt at traversing environment 200. In some implementations, participant 225's adherence to the environment 200 may result in a pass/fail situation. For example, if participant 225 completes environment 200 in less time and with less time penalties than are allotted for environment 200, then participant 225 may be considered to have successfully completed environment 220 and/or all successfully completed maneuvers and/or skills completed within environment 200. Conversely, if participant 225 fails to traverse environment 200 in less time and with less time penalties than are allotted for environment 200, then participant 225 may be considered to not have successfully completed environment 200 and/or all successfully completed maneuvers and/or skills completed within environment 200. In other implementations, participant 225 may receive partial acknowledgement for completing graduation level requirements (e.g., first graduation requirements 640, second graduation requirements 650, and/or the like).

In some implementations, the ‘evaluation during participant graduation evaluated’ step 390 may occur at a later time and/or ceremony. For example, a number of participants 225 may compete in environment 220 for the highest score 250 and/or fastest time, and participants 225 may be ranked and/or acknowledged after every participant 225 has completed environment 200.

The ‘if participant graduation level complete, award next increment of graduation indicia’ step 393 and the ‘if participant graduation level not complete, award no new graduation indicia’ step 396 typically may be determined after participant 225 completes environment 200 in a condition allowing for elevation in participant 225's graduation level. For example, first graduation requirements 640 may require participant 225 to successfully traverse five obstacles 235, complete five skills, and complete an environment 200 containing at least five of the combined five obstacles 235 and five skills within ten minutes and incurring only two deviations 240. If participant 225 has not yet completed and/or attempted environment 200 with more than four obstacles 235 and/or skills, elevation of graduation level may be disregarded. However, where participant 225 has completed each requisite element for his or her current graduation level 610 (e.g., first graduation level 620, second graduation level 630, etc.), scorer 245 and/or another individual associated with system 100 may determine to increment participant 225's graduation level and/or award a new graduation indicia 140.

Example lesson 400 typically may include lesson identifier 403, lesson focus field 405, lesson imagery field 410, multimedia reference icon 415, suggestion field 420, physicality field 425, activity fields 430, customization fields 435, and/or conclusion field 440.

Lesson 400 typically may include guidelines for incrementally teaching and/or improving participant 225's skills in system 100. Lesson identifier 403 typically may denote the particular lesson being viewed with a unique name, title, number, and/or the like. For example, a weekly lesson may contain sequentially numbered and/or labeled lesson identifiers 403 (e.g., Week One, Week Two, etc.). Alternatively, lessons may be less structured and grouped into similar topics, each group being incremented for teaching difficulty and/or participant 225 progression. For example, groups may include, but are not limited to, balance, climbing, jumping, and/or the like, with subgroups having lesson identifiers 403 including, but not limited to, Climbing I, Climbing II, Jumping X, Jumping XI, Balance Lessons 30&31, Balance Classes 32-33, and/or the like. Using lesson identifier 403 may provide an instructor and/or participant with guidance to progress and/or situate within lesson plan 110.

Lesson focus field 405 typically may include instructions and/or guidance regarding a specific lesson topic. For example, lesson focus field 405 may discuss discipline and/or social topics for individuals and/or groups. Lesson focus field 405 may also help focus participant 225 and/or a group, improving communication and/or concentration. In one example, lesson focus field 405 may ask participant 225 to reflect on participant 225's impulses and/or daily regimen.

Lesson imagery field 410 typically may act as a hypothetical and/or audiovisual multimedia guide to emphasize participant 225 and/or groups. For example, lesson imagery field 410 may note, “Imagine you are running through a construction zone and must evade your rival to reach the construction zone's exit while being as efficient as possible to avoid detection.” Lesson imagery field 410 may help to paint a mental picture for participant 225, setting a mood and scene to approach environment 220, obstacles 235, and/or skills. Such factors may be considered for conformity while progressing through environment 200 and/or scoring.

Typically disposed within lesson imagery field 410, multimedia reference icon 415 typically may be an icon representing one or more associated audiovisual resources that depict lesson information and/or depicts of maneuvers, skills, and/or the like. These associated audiovisual resources typically may be stored on multimedia aid 120 but may also be stored on any other suitable medium (e.g., hosted on a local network and/or the Internet, on a DVD, embedded in a presentation, and/or the like). Clicking on and/or otherwise selecting multimedia reference icon 415 typically may navigate an individual to the associated audiovisual resources. Participant 225 and/or other individuals associated with system 100 may view, display, and/or learn from the resources' depictions and/or information to move successfully employ lesson's content. Further, each lesson 400 typically may include one or more multimedia reference icons 415, and each respective multimedia reference icon 415 may reference one or more multimedia resources.

Suggestion field 420 typically may include information helpful to completing lesson and/or contained resources. For example, suggestion field 420 may include safety tips (e.g., “Roll through shoulder when landing from vault to avoid harming neck or head,”) suggested environment 200 designs, potential environment 200 and/or skill variations, and/or the like.

Physicality field 425 typically may suggest strength, endurance, balance, and/or the like activities for participant 225 to perform. For example, these activities may include, but are not limited to, sit-ups, push-ups, pull-ups, box-jumps, balance beam walking, planks, squat jumps, rope climbing, handstands, jogging, wall sitting, and/or the like. These activities may, for example, help participant 225 to build physicality to better perform the current lesson's requirements and/or in preparation for future lessons.

Activity fields 430 typically may include maneuvers for traversing obstacles 235, skills, and/or other activities for participant 225 to perform. In some implementations, activity fields 430 may include one or more subsections, including but not limited to floor, beam, aerial, trampoline, pit, wall, and/or the like. For example, activity fields 430 may include activities such as, but not limited to, wall spin and/or wall run under the wall subsection and/or cat crawl and/or inverted hang under aerial subsection.

In some further implementations, some and/or all activities may be associated with a multimedia resource such as discussed above regarding multimedia resource icon 415. For example, each activity may have an associated multimedia resource icon 415 disposed near the respective activity, each respective activity may be a hyperlink, and/or any other suitable referential redirection mechanism. Associated multimedia may be stored on multimedia aid 120 and/or may also be stored on any other suitable medium (e.g., hosted on a local network and/or the Internet, on a DVD, embedded in a presentation, and/or the like). Clicking on and/or otherwise selecting multimedia reference icon 415 and/or other activity reference typically may navigate an individual to the associated audiovisual resources. As discussed above, participant 225 and/or other individuals associated with system 100 may view, display, and/or learn from the resources' depictions and/or information to move successfully employ lesson's content

Customization fields 435 typically may be spaces disposed adjacent to activity fields 430, which may permit participant 225 and/or other individuals associated with system 100 to tailor lesson 400 activities to that participant 225. For example, participant 225 and/or an instructor may wish to avoid overhead hanging activities due to physical issues, but that participant 225 may be perfectly capable of performing beam and/or floor activities. Thus, these variances from lesson plan 110, lesson 400, and/or activities may be recorded for future record, graduation level tracking, and/or any other purpose.

Conclusion field 440 typically may include closing information and/or techniques to conclude lesson 400. For example, conclusion field 440 may include a mantra, meditation, group activity, and/or the like for participant 225 and/or other individuals associated with system 100 to engage. Such activities may help solidify lesson 400 teaching, reduce physical and/or psychological strain, and/or the like.

FIGS. 5A-5B depict example multimedia aid 120 used with hybrid athletic/martial competition system 100 depicting example first multimedia frame 500 and second multimedia frame 510. First multimedia frame 500 and/or second multimedia frame 510 typically may include title field 520, instructions field 530, demonstrator 540, and/or reference tag 550. Viewing first multimedia frame 500 and second multimedia frame 510 in sequence typically may allow an individual (e.g., participant 225) to view the specifics and/or description of an activity to be completed by participant 225 (e.g., how participant 225 traverses obstacle(s) 235) by another, trained individual (e.g., demonstrator 540).

As depicted in FIG. 5A, first multimedia aid screen 500 typically portrays demonstrator 540 beginning an activity. The activity's title typically may be depicted in title field 520 and instructions for completing the activity typically may be listed in instructions field 530. In some implementations, data displayed in title field 520 and/or instructions field 530 may be dynamically generated based on selected language and/or skill level, while in other implementations, information displayed in title field 520 and/or instructions field 530 may be statically generated.

As depicted in FIG. 5B, second multimedia aid screen 510 typically portrays demonstrator 540 at a slightly later point in time such that demonstrator 540 is in the process of traversing obstacle 235 at a later point. Typically, instructions field 530 may provide additional information if any is to be presented. For example, a first set of information may be displayed in instructions field 530 as demonstrator 540 approaches obstacle 235, and a second set of information may be displayed in instructions field 530 as demonstrator 540 traverses obstacle 235. Typically, a viewer may step through the multimedia resource in a frame-by-frame fashion, allowing the viewer to have a high degree of control and understanding of even highly complex maneuvers. The longitudinal progression from FIG. 5A to FIG. 5B is known in the art with audiovisual multimedia in variable parameters (e.g., variable framerates, multiple angle sources, adjustable depth of field, track overlay, and/or the like).

Reference tag 550 typically may be either embedded into multimedia resource (e.g., first multimedia aid screen 500, second multimedia aid screen, 510, and/or the like) and associated with a multimedia resource reference located on one or more system 100 resources. For example, reference tag 550 may be associated with and linked to elements including, but not limited to, multimedia reference icon 415, activities in activity fields 430, and/or the like. Upon selecting and/or otherwise indicating such a reference link, an individual may be navigated to the associated reference tag 550 and multimedia resource. In some implementations, reference tag 550 may be visible to a viewer (e.g., displayed on first multimedia aid screen 500, second multimedia aid screen 510, etc.) and/or hidden from user (e.g., embedded into multimedia resource and/or blended into first multimedia aid screen 500, second multimedia aid screen 510, etc.).

Graduation guide 600 typically may include graduation levels 610 first graduation level 620, second graduation level 630, first graduation requirements 640, second graduation requirements 650, and/or completion fields 660.

Graduation levels 610 typically may disclose different levels of skill that may be obtained by participants 225. For example, first graduation level 620 and second graduation level 630 typically may represent the lowest two levels awarded in system 100. To be awarded each respective level, participant 225 typically may complete one or more requirements in environment 200. For example, to be acknowledged as a member of first graduation level 620, participant 225 may be required to complete first graduation requirements 640 and to be acknowledged as a member of second graduation level 630, participant 225 may be required to complete second graduation requirements 650. Example graduation requirements are discussed elsewhere in this application.

In some implementations, completion fields 660 may be included to monitor participant 225's progress towards completion of a respective graduation level 610. Completion fields 660 typically may be located adjacent to an associated graduation requirement (e.g., “Complete environment in under five minutes”) and include a box and/or other field for an individual to indicate completion of the associated requirement. For example, an instructor may stamp, initial, punch-out, and/or otherwise indicate sufficient completion.

In overview, hybrid athletic/martial competition system 100 typically may be appealing to all ages. Some objects of the system 100 typically may be to learn to move without interruption through an environment or series of obstacles with fluidity, prowess, and/or stealth and/or to gain skill in the use of combinations of spins, rolls, flips, jumps, kicks, and like maneuvers (such as to elude hypothetical and/or physical opponent(s)). Athletic skills and training that typically may be acquired through system 100 may typically include calisthenics, martial arts, and/or dance. Skill typically may be communicated and/or performed with a maneuver area 215 and a skill area 220, further including one or more entrances 205 and one or more exits 210. Participant's 225 progress through expected participant path 230 while scorer 245 records participant's 225 progress along and deviations 240 from expected participant path 230. Participant's time to advance from entrance 205 to exit 210, through maneuver area 215 and skill area 220, and deviations 240 from expected participant path 230 typically may then be scored by scorer 245 and/or another individual (including participant 225) to determine score 250.

In some implementations, score 250 may be a simple pass/fail for each aspect along expected participant path 230 and deviations 240 from expected participant path 230. Participant 225's score 250 typically may then be compared to graduation guide 130 and participant 225's current graduation level 310 and/or completion fields 660 to determine if participant 225 has sufficiently completed his or her current graduation level 610 (e.g., first graduation level 620) to be incremented to a higher graduation level (e.g., second graduation level 630) and awarded a new graduation indicia 140 associated with the higher graduation level.

The game 100 typically may combine many several sports skills and techniques with others fluidly. Some skills involved in participant's 225 activity in system 100 may include physicality, coordination, linearization of events, direct skill connections, transition skill connections, and/or the like. With environment 200 including strategically placed obstacles 235, the participant 225 typically may use, gain, hone, and master various martial skills to complete the competition 100 objectives.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A hybrid athletic/martial competition kit, comprising:
a lesson plan, wherein the lesson plan further comprises at least one lesson, and wherein the at least one lesson further comprises:
at least one lesson identifier; and
at least one activity field;
at least one multimedia aid, wherein the at least one multimedia aid further comprises:
at least one first multimedia aid screen;
at least one second multimedia aid screen; and
at least one instruction field overlaid on the at least one first multimedia aid screen;
a graduation guide, wherein the graduation guide further comprises at least one graduation level, and wherein the at least one graduation level further comprises:
a first graduation level, wherein the first graduation level further comprises at least one first graduation requirement; and
a second graduation level, wherein the second graduation level further comprises at least one second graduation requirement and
wherein the at least one second graduation requirement is more physically challenging to perform than the at least one first graduation requirement.

2. The hybrid athletic/martial competition kit of claim 1, further comprising:
at least one graduation indicia associated with the at least one graduation level.

3. The hybrid athletic/martial competition kit of claim 1, further comprising:
at least one obstacle.

4. The hybrid athletic/martial competition kit of claim 1, further comprising:
at least one multimedia reference icon, wherein the at least one multimedia reference icon is generated and displayed on the at least one lesson; and
at least one reference tag, wherein the at least one reference tag corresponds to the at least one multimedia reference icon.

5. The hybrid athletic/martial competition kit of claim 1, further comprising:
at least one scoring guide.

6. The hybrid athletic/martial competition kit of claim 1, wherein the at least one multimedia aid is an audiovisual presentation.

7. A system for hybrid athletic/martial training, comprising:
a lesson plan, wherein the lesson plan further comprises at least one lesson describing at least one athletic training activity, and wherein the at least one lesson further comprises:
at least one lesson identifier, wherein the at least one lesson identifier uniquely identifies the at least one lesson; and
at least one activity field, wherein the at least one activity field describes the at least one athletic training activity to be taught by the at least one lesson;
at least one multimedia aid associated with the at least one lesson, wherein the multimedia aid further comprises:
at least one first multimedia aid screen;
at least one second multimedia aid screen encoded chronologically after the at least one first multimedia aid screen; and
at least one instruction field overlaid on the at least one first multimedia aid screen describing the at least one athletic training activity; and
a graduation guide, wherein the graduation guide further comprises at least one graduation level, and wherein the at least one graduation level further comprises:
a first graduation level, wherein the first graduation level further comprises at least one first graduation requirement; and
a second graduation level, wherein the second graduation level further comprises at least one second graduation requirement and
wherein the at least one second graduation requirement is more physically challenging to perform than the at least one first graduation requirement.

8. The system for hybrid athletic/martial training of claim 7, further comprising:
at least one obstacle, the at least one obstacle traversable during the at least one athletic training activity.

9. The system for hybrid athletic/martial training of claim 7, further comprising:
at least one graduation indicia, wherein the at least one graduation indicia uniquely represents the at least one graduation level.

10. The system for hybrid athletic/martial training of claim 7, further comprising:
at least one scoring guide, wherein the at least one scoring guide sets conditions for the at least one first graduation requirement.

11. The system for hybrid athletic/martial training of claim 7, wherein the lesson plan, the at least one multimedia aid, and the graduation guide are stored on digital storage media.

12. The system for hybrid athletic/martial training of claim 7, wherein the at least one multimedia aid is an audiovisual presentation.

13. A hybrid athletic/martial game kit, comprising:
a lesson plan, wherein the lesson plan further comprises at least one lesson, wherein the at least one lesson describes at least one hybrid athletic/martial activity, and wherein the at least one lesson further comprises:
at least one lesson identifier; and
at least one activity field;
at least one multimedia aid, wherein the at least one multimedia aid further comprises:
at least one first multimedia aid screen;
at least one second multimedia aid screen;
at least one instruction field overlaid on the at least one first multimedia aid screen; and
at least one reference tag corresponding to the at least one lesson;
a graduation guide, wherein the graduation guide further comprises at least one graduation level, and wherein the at least one graduation level further comprises:
a first graduation level, wherein the first graduation level further comprises at least one first graduation requirement; and
a second graduation level, wherein the second graduation level further comprises at least one second graduation requirement, and wherein the at least one second graduation requirement requires greater skill for a participant to perform than the at least one first graduation requirement.

14. The hybrid athletic/martial game kit of claim 13, further comprising:
at least one graduation indicia associated with the at least one graduation level.

15. The hybrid athletic/martial game kit of claim 13, further comprising:
at least one obstacle.

16. The hybrid athletic/martial game kit of claim 13, further comprising:
at least one multimedia reference icon, wherein the at least one multimedia reference icon is generated and displayed on the at least one lesson, and wherein the at least one multimedia reference icon corresponds to the at least one reference tag.

17. The hybrid athletic/martial game kit of claim 13, further comprising:
at least one scoring guide.

18. The hybrid athletic/martial game kit of claim 13, wherein the at least one multimedia aid is an audiovisual presentation.

19. The hybrid athletic/martial game kit of claim 13, wherein the at least one lesson further comprises:
at least one lesson focus field;
at least one suggestion field;
at least one physicality field;
at least one customization field; and
at least one conclusion field.
